(19) United States
(12) Patent Application Publication
(10) Pub. No.: US 2026/0019493 A1
(43) Pub. Date: Jan. 15, 2026

(54) SYSTEM AND METHOD FOR SMARTPHONE MONITORING, RESTRICTION, AND RISK DETECTION

(71) Applicant: Cyber-Dive Corp, Mesa, AZ (US)

(72) Inventors: Jeff Gottfurcht, Scottsdale, AZ (US); Derek Q. Jackson, Phoenix, AZ (US); Harshini Kanukuntla, Mesa, AZ (US); Siddhesh Rajesh Rao, Tempe, AZ (US); Narasimha Siva Saketh Emani, Mesa, AZ (US); Rashmi Atul Bongirwar, Phoenix, AZ (US); Kelli Jackson, Gilbert, AZ (US); Abhishek Aggarwal, Shimla (IN); Austin Leung, San Francisco, CA (US); Cibelle Montor, Gilbert, AZ (US); Clement Beschu, Washington, DC (US); Drashti Dave, Seattle, WA (US); Elijah Bowers, Gilbert, AZ (US); Muhammed Ihtisham Arif, Frisco, TX (US); Jordan Arnold, Phoenix, AZ (US); Raghav Gupta, Tempe, AZ (US); Ramii Ahmed Ramy Mahmoud Zaki, Cairo (EG); Rohan Ippalapally, Tempe, AZ (US); Shivansh Agarwal, Tempe, AZ (US); Viraj Ulhas Thakur, Tempe, AZ (US)

(21) Appl. No.: 19/332,176

(22) Filed: Sep. 18, 2025

Related U.S. Application Data
(63) Continuation of application No. 18/742,839, filed on Jun. 13, 2024.
(60) Provisional application No. 63/695,850, filed on Sep. 18, 2024.

(51) Int. Cl. H04M 1/72463; H04L 67/50

(52) U.S. Cl. CPC H04M 1/72463; H04L 67/535

(57) ABSTRACT

A smartphone monitoring and restriction system is disclosed. The system employs on-device machine learning to detect nudity in images captured by the device camera, triggering automatic device lock and multi-channel alerts to a parent dashboard. The dashboard allows parents to review flagged media, unlock the device, or delete content. Additional features include selective recording of newly installed applications based on risk-tagged metadata, suspicious conversation detection using natural language processing, and monitoring of stored, dialed, or messaged contacts against curated databases. Parents may also initiate live audio capture for environmental assessment, configure curfews with override capability, and enforce grounding or full lockdown states. An enterprise version supports institutional use, enabling administrators to assign devices, apply stage-based restrictions, monitor resident activity, dispatch surveys, and manage incentives. The system provides layered safety controls, real-time monitoring, and feedback loops to improve detection accuracy and oversight in both parental and organizational contexts.

### CROSS-REFERENCE TO RELATED APPLICATIONS

This application is a continuation in part application to U.S. Nonprovisional application Ser. No. 18/742,839 filed Jun. 13, 2024 and this application claims priority to Provisional Patent Application Ser. No. 63/695,850 filed Sep. 18, 2024, which are each hereby incorporated in its entirety at least by reference.

### BACKGROUND OF THE INVENTION

### 1. Field of the Invention

The present invention relates to smartphones but more particularly to a system and method for smartphone monitoring, restriction, and risk detection.

### 2. Description of Related Art

With the proliferation of mobile technology, smartphones have become deeply integrated into the daily lives of individuals, including children. These devices provide significant benefits, including enhanced communication, access to educational resources, and entertainment opportunities. At the same time, they present substantial risks for younger users, including exposure to inappropriate content, susceptibility to cyberbullying, and unsupervised interactions with strangers.

Existing parental control technologies attempt to address these concerns by enabling limited monitoring of calls, messages, and application usage, or by restricting device access based on schedules or content ratings. While useful in certain contexts, these solutions often require extensive configuration by parents, are prone to circumvention by technologically adept children, and typically lack comprehensive coverage across the diverse activities and communication modes available on modern smartphones. Moreover, current systems may fail to provide real-time risk detection or seamless integration of parental feedback to improve monitoring accuracy.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is an object of the present invention to provide a comprehensive system for monitoring and restricting smartphone usage among children that enhances safety and promotes responsible usage through advanced technology and software.

In one embodiment, the system provides on-device machine-learning detection of nudity in captured images with automatic device lock and multi-channel parental alerts; selective application recording and uninstall workflows based on risk-tagged metadata; detection of suspicious conversational activity using transformer-based models with a parent feedback loop; cross-referencing of stored/dialed/messaged contacts against curated offender and risk databases; grounding/curfew enforcement and optional live audio capture with distress analysis; and, in alternative embodiments, implementation as a custom mobile operating system and/or an enterprise device-management portal supporting phase-based policies, surveys, incentives, and manager messaging. Flagged events across modules are surfaced to a Parent Dashboard for review and action.

In alternate embodiments, the system is deployed in enterprise contexts, where a device-management portal allows managers to configure curfews, assign phase-based restrictions, dispatch mandatory surveys, manage resident incentives, process offsite requests, and communicate securely with residents.

In order to do so, in one aspect of the invention, a mobile device is provided, the device including a camera, a display, a processor, and a memory storing instructions that, when executed by the processor, cause the device to analyze images captured by the camera using a machine learning model, determine whether the images include nudity, and in response to detecting nudity, lock the device and generate a notification for transmission to a parent dashboard, wherein the device is configured to restore access only upon receiving an authorized unlock input.

In one embodiment, the mobile device is further configured to process the captured images within a predetermined time to enable real-time nudity detection and enforcement of device restrictions.

In another embodiment, the mobile device is configured to transmit a record of a flagged session to a backend server, including a screenshot of the detected content and a session recording, for display and review at the parent dashboard.

In another aspect of the invention, a method is provided for controlling application installations on a mobile device, the method including detecting an application installation event, collecting application metadata, evaluating the metadata for risk factors, generating a risk-tagged metadata package, and transmitting a notification to a parent dashboard that presents decision options including selective recording, uninstallation, or no action.

In one embodiment, if a parent selects “don't record,” the application remains installed but its activity is hidden from the dashboard feed while camera-based monitoring and nudity detection remain active.

In another embodiment, once an application is uninstalled through the dashboard, the uninstallation cannot be reversed within the system.

In another aspect of the invention, a system is provided for monitoring text conversations on a child's device, the system including a transformer-based natural language processing model trained to identify grooming and other risky behaviors, wherein flagged conversations are displayed on a parent dashboard along with contextual messages and risk tags, and wherein parent feedback is used to retrain the model and reduce false positives.

In another aspect of the invention, a system is provided for monitoring contacts stored, dialed, or messaged on a child's device, wherein contacts are compared against a curated database of suspicious entities, flagged results are displayed on a parent dashboard, and parents may provide feedback to refine alerts and update contact status.

In another aspect of the invention, a system is provided for initiating and analyzing live audio recordings from a child's device, wherein a parent request through a dashboard triggers the device to capture environmental audio in short segments, upload the audio for transcription and tone analysis, and generate an alert when distress is detected above a confidence threshold.

In another aspect of the invention, a system is provided for configuring and enforcing curfew functionality, wherein parents or administrators schedule device curfews through a dashboard, the device enforces curfew overlays and restrictions, and authorized overrides permit temporary dismissal of curfew rules.

In another aspect of the invention, a system is provided for onboarding residents in institutional programs, wherein administrators create resident profiles, assign devices by scanning a setup code, apply phase-based restrictions, and monitor resident activity through a centralized dashboard.

The foregoing has outlined rather broadly the more pertinent and important features of the present disclosure so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1A is a flow diagram illustrating device lock and unlock code handling for a nudity detection module, according to an embodiment of the present invention.

FIGS. 1B-1D are flow diagrams illustrating screenshot capture, image processing, and notification handling for the nudity detection module, according to an embodiment of the present invention.

FIGS. 2A-2B are flow diagrams illustrating selective recording and uninstallation of applications installed on a child's device, according to an embodiment of the present invention.

FIGS. 3A-3B are flow diagrams illustrating detection of suspicious or risky text conversations on a child's device, according to an embodiment of the present invention.

FIG. 4 is a flow diagram illustrating monitoring of contacts and identification of suspicious contacts, according to an embodiment of the present invention.

FIGS. 5A-5B are flow diagrams illustrating initiation and analysis of live audio recordings from a child's device, according to an embodiment of the present invention.

FIG. 6 is a flow diagram illustrating configuration, enforcement, and override of curfew functionality, according to an embodiment of the present invention.

FIG. 7 is a flow diagram illustrating resident creation, device assignment, and onboarding with phase-based restrictions in institutional settings, according to an embodiment of the present invention.

FIG. 8 is a network diagram illustrating communication between a child's device, a backend server, and a parent dashboard, according to an embodiment of the present invention.

FIG. 9 is a block diagram of the smartphone and system architecture, according to an embodiment of the present invention.

### DETAILED DESCRIPTION OF THE INVENTION

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a system and method for smartphone monitoring, restriction, and risk detection.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

In one embodiment, the present invention provides a robust real-time monitoring of images captured on a mobile device, specifically targeting the detection of nudity. When the device camera is used to capture an image that includes private body parts, an embedded machine learning (ML) model analyzes the image in real time. If the ML model identifies the content as nudity, the image is flagged. Once an image is flagged, the device automatically locks to prevent further use, thereby ensuring that the user cannot continue capturing or accessing additional content. Simultaneously, the system generates a notification to a parent or guardian through multiple communication channels, including text, email, and SMS, which may include a session record and a representation of the flagged image. Advantageously, this multi-channel alert ensures that the parent is promptly informed and can take timely action. The device remains locked until the parent decides to unlock it through a parent dashboard, where the flagged image can be reviewed and a decision made to retain or delete the media.

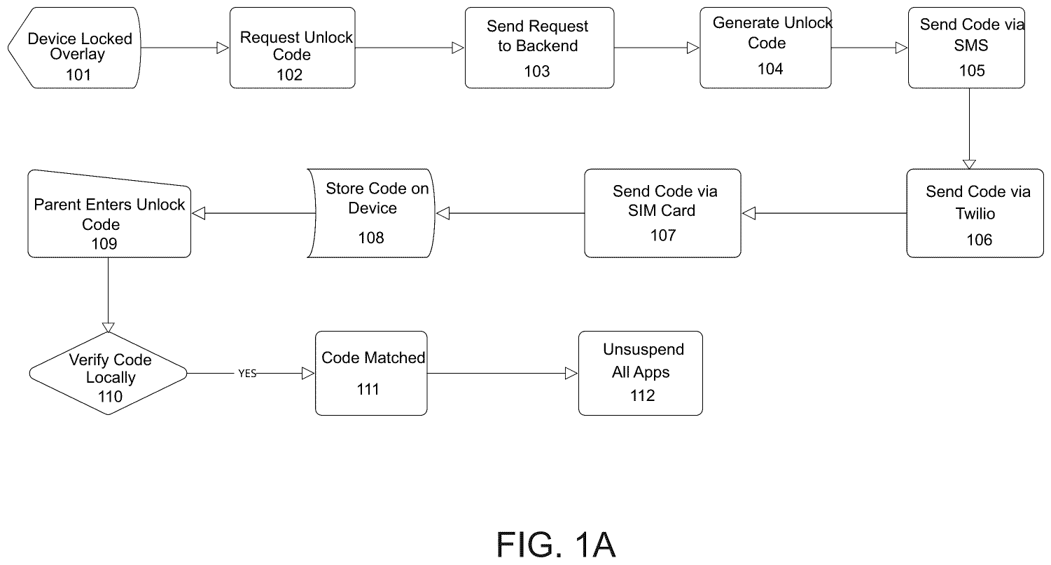

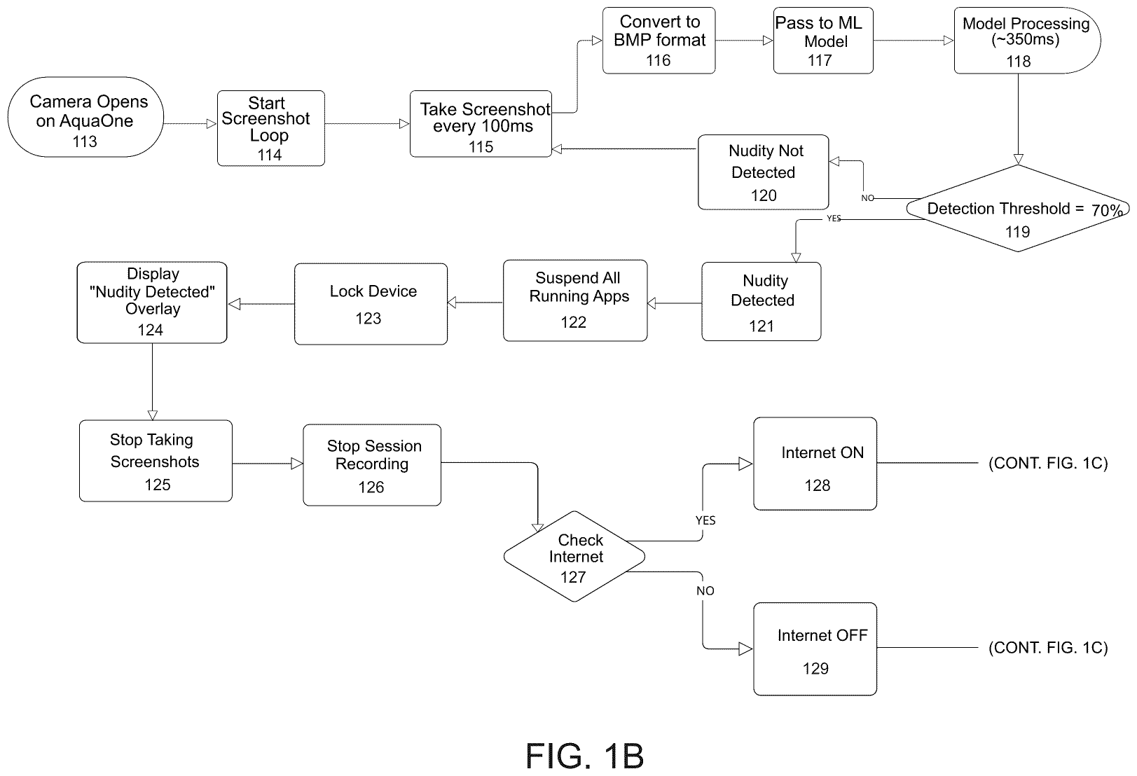

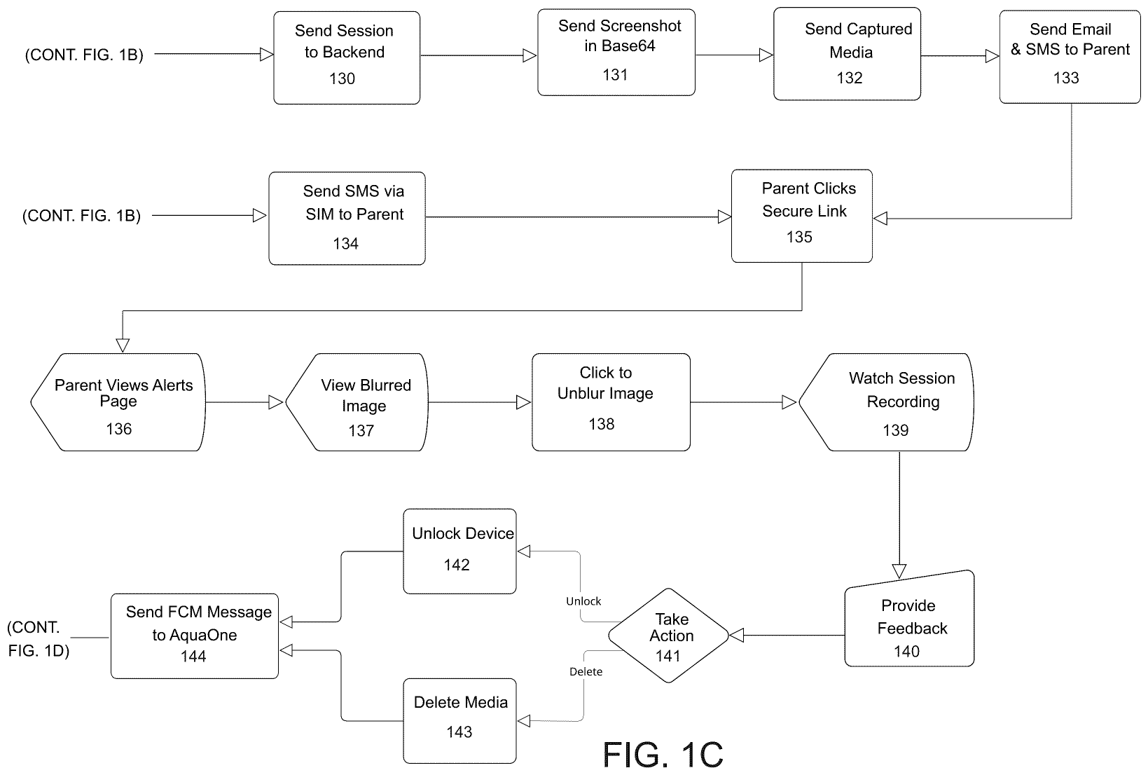

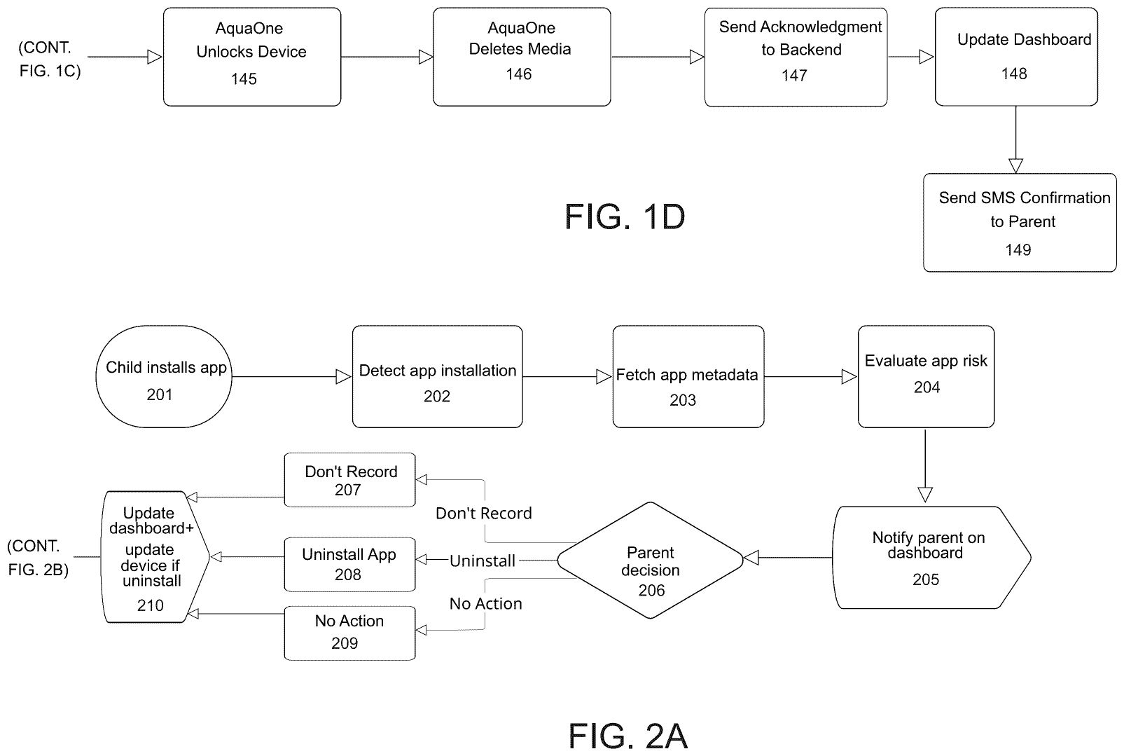

FIGS. 1A-1D illustrate system flowcharts related to the nudity detection module. Referring now to FIG. 1A, a portion of the flow diagram relating to device lock and unlock code handling is provided. In step 101, when nudity is detected, the system presents a locked-device overlay on the display to prevent further access to the device. In step 102, the user may initiate a request to unlock the device by selecting a corresponding option presented on the overlay. In step 103, the device transmits an unlock request to a backend service. In step 104, the backend generates an unlock code. In steps 105-107, the generated code is transmitted to the parent or guardian by one or more communication channels, such as via SMS, via a third-party service such as Twilio, or via a SIM card message. In step 108, the unlock code is also stored locally on the device. In step 109, the parent or guardian enters the unlock code into the device. In step 110, the device verifies the entered code locally against the stored code. If the code matches, as determined in step 111, then in step 112 all suspended applications are unsuspended and normal operation of the device is restored. If the code does not match, the device remains locked pending entry of a valid code.

Referring now to FIG. 1B-D, the stages of monitoring and detection using a machine learning (ML) model for the nudity detection module is illustrated. In step 113, the camera opens on the AquaOne (present invention) device. In step 114, the system initiates a screenshot loop in which screen images are captured at a defined interval, such as every 100 milliseconds (115; FIG. 1B). In step 116, each screenshot is converted into a bitmap (BMP) format image. In step 117, the BMP image is passed to an embedded ML model for classification, wherein the ML model processes the image, with processing typically requiring approximately 350 milliseconds (118; FIG. 1B). In step 119, the system applies a detection threshold, such as 70%, to the ML output to determine whether the image includes nudity. In step 120, if nudity is not detected the system returns to step 114/115. In step 121, if nudity is detected, the system transitions to step 122, in which all running applications are suspended. In step 123, the device is locked, and then in step 124 the device displays “Nudity Detected” via an overlay message. Next, in steps 125 and 126 the system stops taking screenshots and any session recording is halted. In step 127, the system determines whether an internet connection is available, which leads to the operations shown in FIG. 1C.

If the internet is on (128; FIG. 1B), then in step 130 the device transmits a record of the session to a backend server. In step 131, a screenshot of the flagged content is sent to the backend encoded in Base64 format. In step 132, captured media is also transmitted, and in step 133 notifications are sent to a parent or guardian by email and SMS. If the internet is off (129; FIG. 1B), then in step 134 an SMS is transmitted directly to the parent using the SIM card of the device. In step 135, the parent receives a secure link to access an alert page (136; FIG. 1C). In step 137, the parent may view a blurred version of the flagged image, and in step 138, the parent may select to unblur the image. In step 139, the parent may watch the session recording, and in step 140, the parent may provide feedback. In step 141, the parent may take action, including unlocking the device 142 or deleting flagged media 143. In step 144, a Firebase Cloud Messaging (FCM) signal is sent to the device, which instructs the AquaOne client to unlock the device (step 145, FIG. 1D) and deletes the flagged media (step 146, FIG. 1D). In steps 147-148, an acknowledgment is returned to the backend and the dashboard is updated accordingly. Finally, in step 149, an SMS confirmation may also be transmitted to the parent.

In one embodiment, the system provides parents with enhanced control over their child's application installations by enabling selective recording or uninstallation of applications after download. When a child selects an application from an online app store and initiates installation, the process triggers a notification to the parent. The parent can then decide whether to allow the application to remain installed while selectively recording its activity, uninstall the application, or take no action. This ensures that each app installation is vetted by the parent, thereby providing an additional layer of security and oversight. Upon receiving the notification, the parent is presented with detailed application information, including name, description, developer, permissions, and other metadata, directly within the parent dashboard. By allowing parents to selectively record only those apps deemed necessary, this feature reduces clutter in the activity feed while maintaining comprehensive device safety monitoring. The overall flow of this process consists of three stages: (i) the child initiates the installation of an app, (ii) the system generates a notification requiring parental approval, and (iii) the parent reviews the application details and makes a decision via the dashboard interface. The parent may later revise this decision, including changing review tags or adjusting recording preferences, while system-level protections remain continuously active.

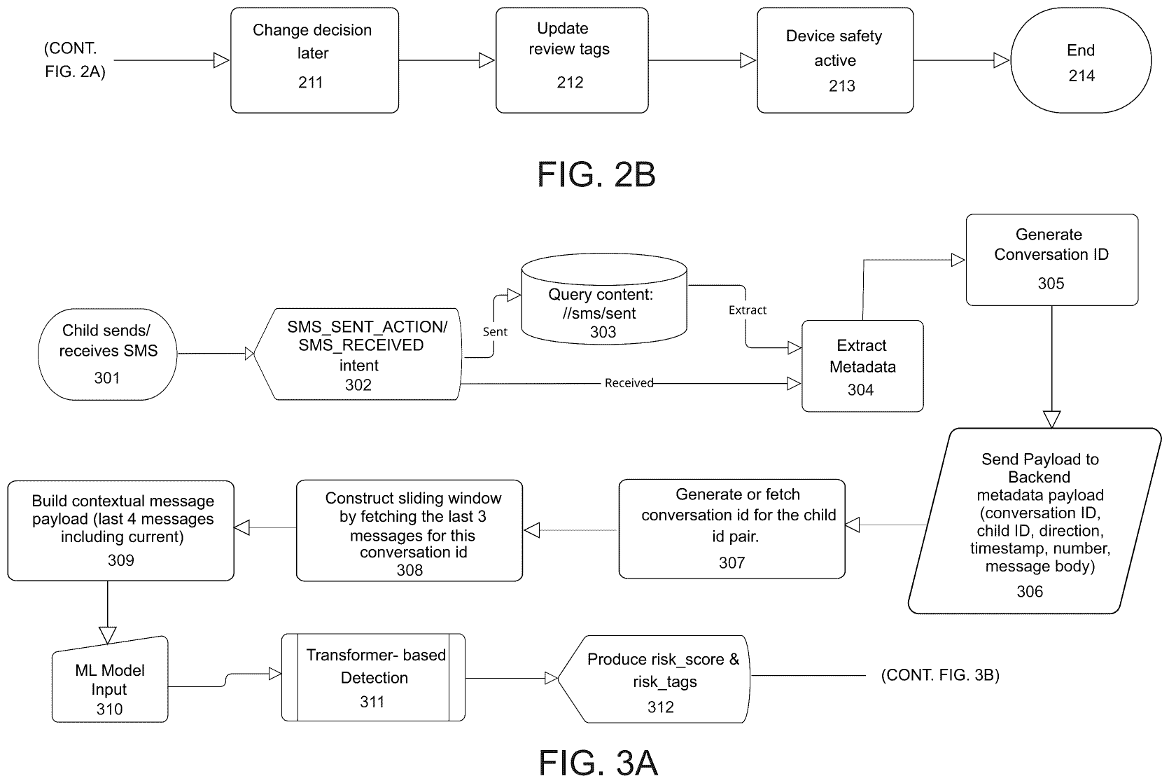

FIG. 2A-B illustrates the beginning of a flow diagram for selective recording of apps installed on a child's device. In step 201, the child initiates installation of an application on the device. In step 202, the system detects the app installation event. In step 203, metadata of the application is fetched. The system collects metadata including, but not limited to: application name, icon, package name, developer name, category, description, content rating (e.g., Everyone, Teen, 17+), average rating, number of reviews, install count, last updated date, and version. Additionally, the system identifies requested permissions such as access to camera, microphone, location, SMS, contacts, overlay, and usage statistics. In step 204 (FIG. 2A), the system evaluates the application for risk factors using the metadata obtained in step 203. Certain categories of indicators are considered: (a) Adult content indicators. For example, the system may flag an app if its content rating is 17+ or 18+, or if the app name or description includes terms such as “flirt,” “hookup,” “18+,” “cam,” “singles nearby,” or “NSFW.” Similarly, apps categorized as Dating, Live Streaming, or Private Chat are flagged as potentially adult-oriented. (b) Risky permissions. Apps requesting sensitive permissions such as camera, microphone, SMS, location, overlay, or usage statistics are flagged, especially if such requests are not justified by the app's stated category or purpose. (c) Risky categories. Apps that fall under categories such as Dating, Anonymous Chat, VPN or Proxy tools, or Hidden Browsers/Private Storage are flagged as risky, as they may allow circumvention of monitoring or exposure to inappropriate interactions. (d) Unverified developer flag. Apps from developers with a history of publishing adult, harmful, or deceptive content, or developers with no established reputation or store history, may also be flagged. The result of this evaluation step is a risk-tagged metadata package, which combines the app's descriptive attributes with assigned risk flags. This package forms the basis of the parental dashboard notification, allowing the parent to quickly understand why an app may be considered unsafe or inappropriate. Following risk evaluation, the dashboard notification includes (i) the app name, icon, and developer; (ii) the full metadata package collected; and (iii) the assigned flags. The notification further presents decision buttons for “Don't Record,” “Uninstall,” or “No Action.”

In step 205, the system notifies the parent through a dashboard interface that a new app installation is in progress and under review. The dashboard notification also includes decision buttons, and in step 206, the parent makes a decision regarding the app, wherein the options include: “Don't Record” (step 207), “Uninstall App” (step 208), or “No Action” (step 209). In step 210, if the parent elects to uninstall the app, the dashboard and device are updated to reflect the action. If no action is taken, the app remains but its activity is displayed on the dashboard feed. If “Don't Record” is selected, the application remains installed on the device. In this case, the app's activity is hidden from the parent's feed, thereby reducing clutter in the dashboard view. However, all safety monitoring functions remain active. In particular, nudity prevention remains enabled. If the application attempts to access the camera and the child opens it, the system will (i) detect the camera usage, (ii) take screenshots, (iii) run on-device nudity detection against the captured images, and (iv) transmit an alert to the parent if nudity is detected.

Next, In step 211, parents may later change their decision, such as updating review tags or toggling whether the app is recorded. For example, a “Don't Record” decision disables only feed visibility but does not disable camera-based monitoring; nudity detection and related safety functions remain continuously active. The classification of an app may also change over time. If new metadata or updated information causes an application to be reclassified—for example, an adult content flag is added at a later date —the system updates the app's status and applies new flags accordingly. Parents retain control over whether to update review tags or modify selective recording preferences. However, risky or adult-flagged applications are never automatically uninstalled by the system; uninstallation remains solely at the discretion of the parent. Importantly, once a parent elects to uninstall an application, that decision cannot be reversed through the dashboard. While “Don't Record” or “No Action” choices may be updated at a later time, an uninstall action permanently removes the application and cannot be undone within the system.

In step 212, the system updates review tags associated with the app to reflect new classification information or parental decisions. In step 213, the device safety system remains active regardless of recording status, ensuring that risky apps cannot bypass monitoring. In step 214, the process ends, with the parent's decision reflected in the dashboard and the device behavior updated accordingly.

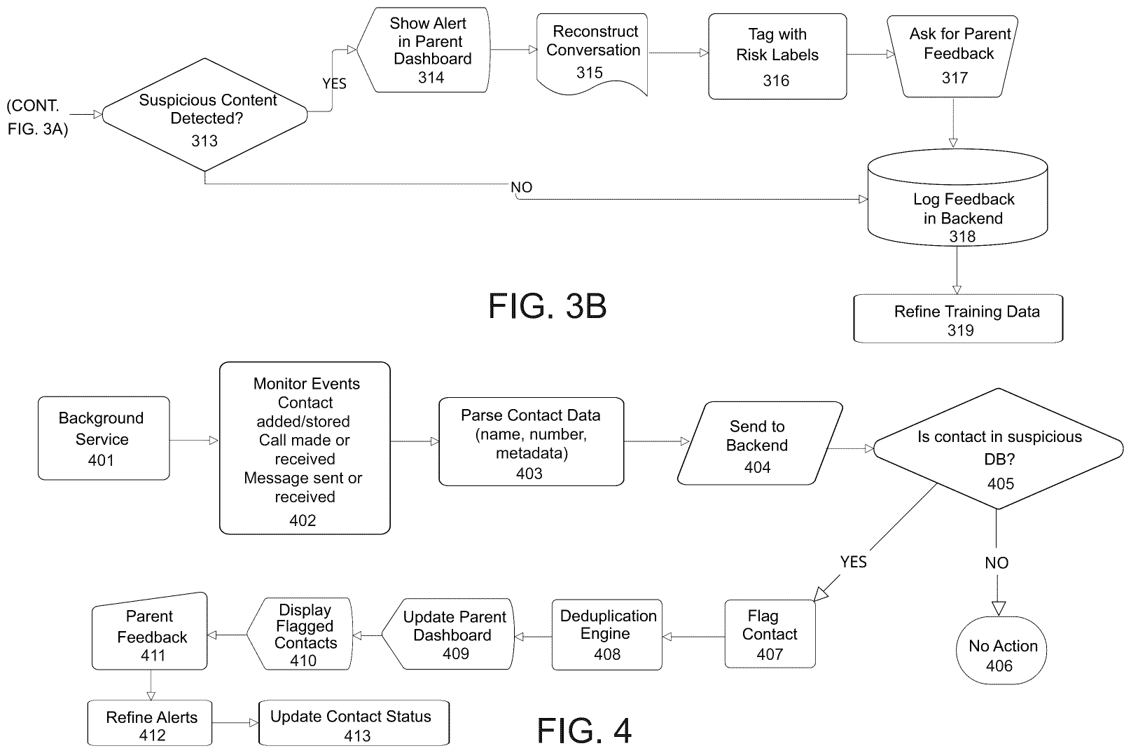

FIGS. 3A-3B illustrate an embodiment in which the system monitors SMS text conversations on a child's device to detect suspicious or risky exchanges. The model can identify patterns such as when the child conceals information, admits to lying, is asked if they are alone or unsupervised, or attempts to hide or delete messages. Such patterns may indicate grooming or other unsafe behavior. When these risks are detected, the conversation is flagged and displayed as an alert in the parent dashboard. Parents are asked to provide feedback regarding whether the conversation appears suspicious, and this feedback is logged to refine training data and retrain the detection model, thereby reducing false positives over time.

In step 301, the child sends or receives SMS text messages, and in step 302, the system intercepts outgoing and incoming text messages by monitoring SMS_SENT_ACTION and SMS_RECEIVED intents. In step 303, the system queries the device message content provider, such as content://sms/sent, to obtain message data. In step 304, metadata is extracted from the message. In step 305, a conversation identifier is generated. In step 306, a contextual window is constructed by fetching recent messages for the conversation. In step 307, a four-message window (including the current message) is built to preserve conversational dynamics. In step 308, the message window is processed by a transformer-based natural language processing model (e.g., BERT or DistilBERT) trained on curated datasets. In one embodiment, the model may be implemented using publicly available transformer-based architectures such as BERT or DistilBERT, fine-tuned on annotated chat corpora including grooming detection logs, toxic communication corpora, and curated conversational datasets. In step 309, the model outputs a risk score (0-1) and one or more risk tags (e.g., manipulation, isolation, sexual language). In step 310, the system compares the score to a threshold. In step 312, the model produces a risk score, typically expressed as a float between zero and one, along with one or more risk tags such as manipulation, isolation, or sexual language. If the risk score exceeds a defined threshold (step 311), the system generates an alert in the Parent Dashboard (step 312) that displays up to eight recent messages for context and annotates the conversation with risk tags. The parent is prompted for feedback (e.g., Yes/No/Not Sure) (step 313). Parent feedback is logged (step 314) and used to refine training data and model parameters (step 315). If the threshold is not exceeded at step 310, no alert is raised and monitoring continues.

Next, In step 317, parents are asked to confirm whether the conversation appears suspicious, with responses such as yes, no, or not sure. In step 318, parent feedback is logged in the backend and used to refine the training data for the model (319), improving the system's ability to identify actual risks while reducing false positives. Back in step 313, if the risk score does not exceed the threshold, no alert is raised, and the system continues to monitor subsequent messages in the background.

FIG. 4 is a flow diagram illustrating monitoring of stored, dialed, and messaged contacts and flagging of suspicious contacts for display on a parent dashboard. Referring now to FIG. 4, the system includes a background service that continuously monitors contact events such as when a new contact is added or stored, when a call is made or received, or when a message is sent or received (steps 401-402). In step 403, contact data is parsed to extract relevant information, including name, phone number, and associated metadata. Next in step 404, the parsed data is transmitted to the backend service, which compares the information against a curated database of suspicious entities (in step 405). The database may contain entries for known predators, registered sex offenders, reported scam callers, and other flagged entities, and matching may be performed using phone numbers, aliases, emails, or user handles.

If the contact does not appear in the database, no action is taken and monitoring continues (step 406). If a match is found, the contact is flagged (step 407). A deduplication engine ensures that no duplicate flags are created and that each flagged contact is represented by a unique parent-facing record (step 408). In step 409, the flagged contact is then displayed on the parent dashboard, where details such as name, phone number, type of interaction (e.g., call, SMS, saved contact), time of last activity, and a risk label (e.g., “High Risk,” “Watchlist,” “Known Offender”) are shown (410). The dashboard supports sorting, filtering, and search, as well as real-time updates with new logs.

In step 411, parents can provide feedback on each flagged contact, such as marking the contact as safe, confirming suspicion, adding internal notes, or downloading a report. The backend uses this feedback to refine alerts (step 412) and update contact status (step 413), ensuring that future notifications are more accurate and aligned with parental input.

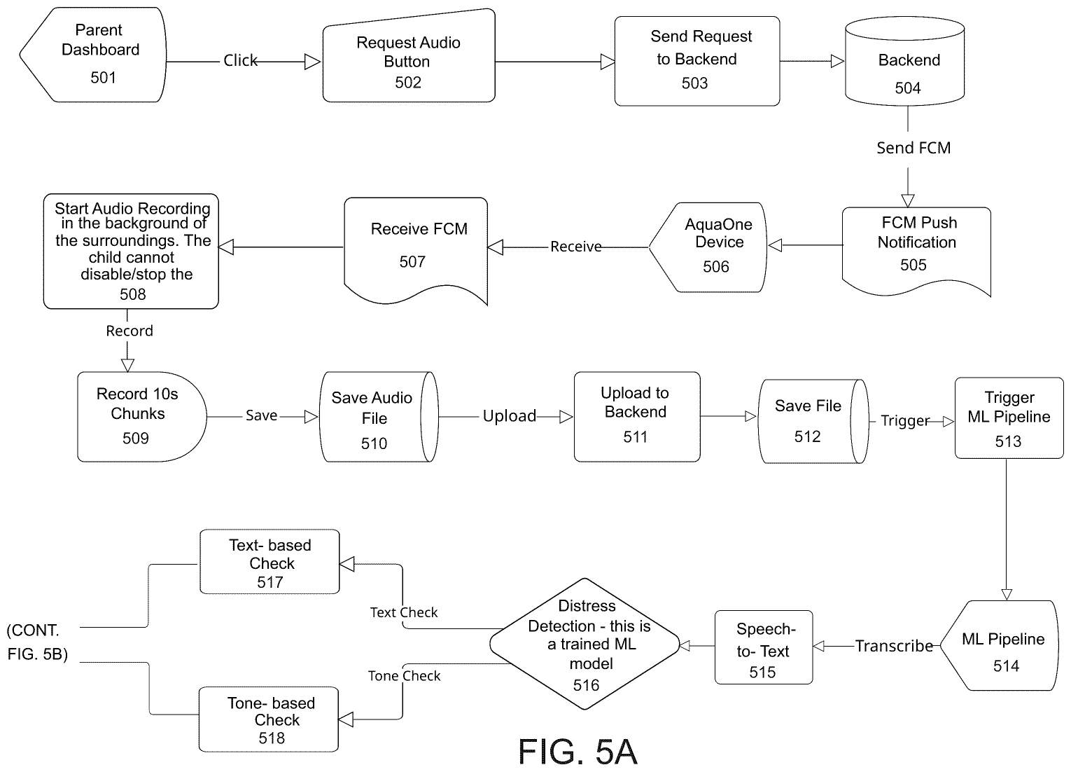

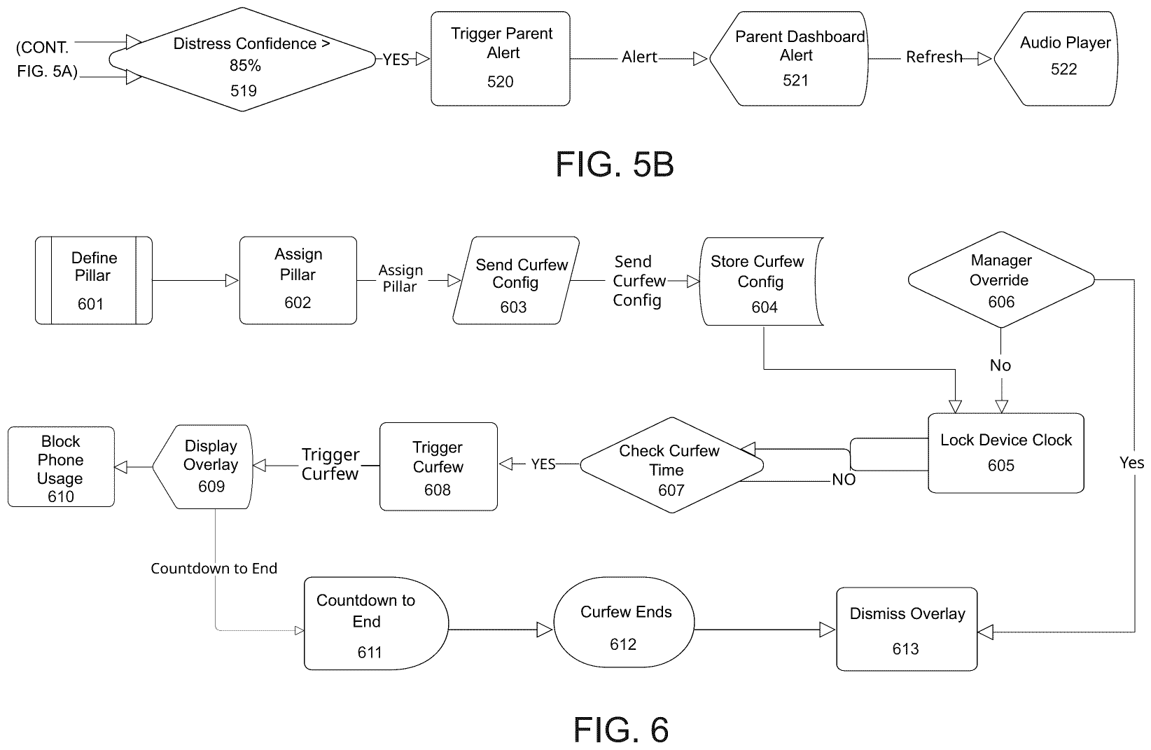

FIGS. 5A-5B are flow diagrams illustrating a system for remotely initiating and analyzing live audio recordings from a child's device. In one embodiment, a parent can initiate live audio capture from the child's device via the dashboard. The device records in short, non-interruptible chunks and uploads audio to the backend, where a machine-learning pipeline transcribes the audio and analyzes both lexical content and vocal tone for distress. If distress exceeds a configurable threshold (e.g., 85%), an alert is displayed in the dashboard with an audio player.

Referring now to FIGS. 5A-B, in step 501, the parent initiates an audio request from the dashboard. In step 502, the request is transmitted to the backend. In step 503, the backend sends a push notification through a cloud messaging service to the device. In step 504, the device receives the push and, in step 505, begins background audio recording that cannot be disabled by the child.

In step 509, the device records audio in segments, such as 10-second chunks. In step 510, each audio chunk is saved as a file, and in step 511 the file is uploaded to the backend. In step 512, the backend saves the uploaded audio and, in step 513, triggers a machine learning pipeline (514). In step 515, the audio is processed through a speech-to-text module to generate a transcription. In step 516, a distress detection model analyzes the transcription and the acoustic features of the recording. In step 517 and 518, the model performs both text-based checks and tone-based checks to identify signs of distress. In step 519, if the model determines that the distress confidence exceeds a defined threshold, such as 85%, then in step 520 an alert is triggered to the parent dashboard (521). In step 522, the dashboard displays an alert with an audio player so the parent may listen to the recording and refresh the alert status. If the distress threshold is not exceeded, no alert is generated and monitoring continues.

FIG. 6 is a flow diagram illustrating curfew configuration, enforcement, and override functionality. In one embodiment, the system enables parents or administrators to enforce scheduled curfews on a child's device. A curfew may be defined as a restricted usage period during which device access is limited. Parents can configure curfew parameters through a dashboard interface, assign the configuration to a device, and transmit the rules for enforcement. During curfew, the device may display an overlay and block access to non-essential functions. At the scheduled end time, or upon authorized override, the restrictions are lifted. This feature provides structured control over device use, ensuring compliance with routines such as bedtimes or study periods, while preserving the ability for managers to override or dismiss curfew restrictions when appropriate.

Referring now to FIG. 6, in step 601 a curfew pillar is defined; in step 602 the pillar is assigned; in step 603 a curfew configuration is sent to the device; and in step 604 the configuration is stored locally. In step 605 the device checks current time against the curfew schedule. If the curfew start is reached, curfew mode is triggered (step 606); an overlay is displayed (step 607); and device usage is blocked in accordance with curfew rules (step 608). In step 609 a countdown shows time remaining. When the scheduled end time is reached, curfew ends and restrictions are lifted (step 610), and the overlay is dismissed (step 611). In step 612 a manager override may be exercised to dismiss the overlay and bypass restrictions; if no override occurs, enforcement continues until the countdown completes. A manager override can dismiss the overlay and bypass restrictions, thereby allowing temporary suspension of curfew rules. If no override is exercised, curfew enforcement continues until completion of the countdown and natural expiration of the curfew period.

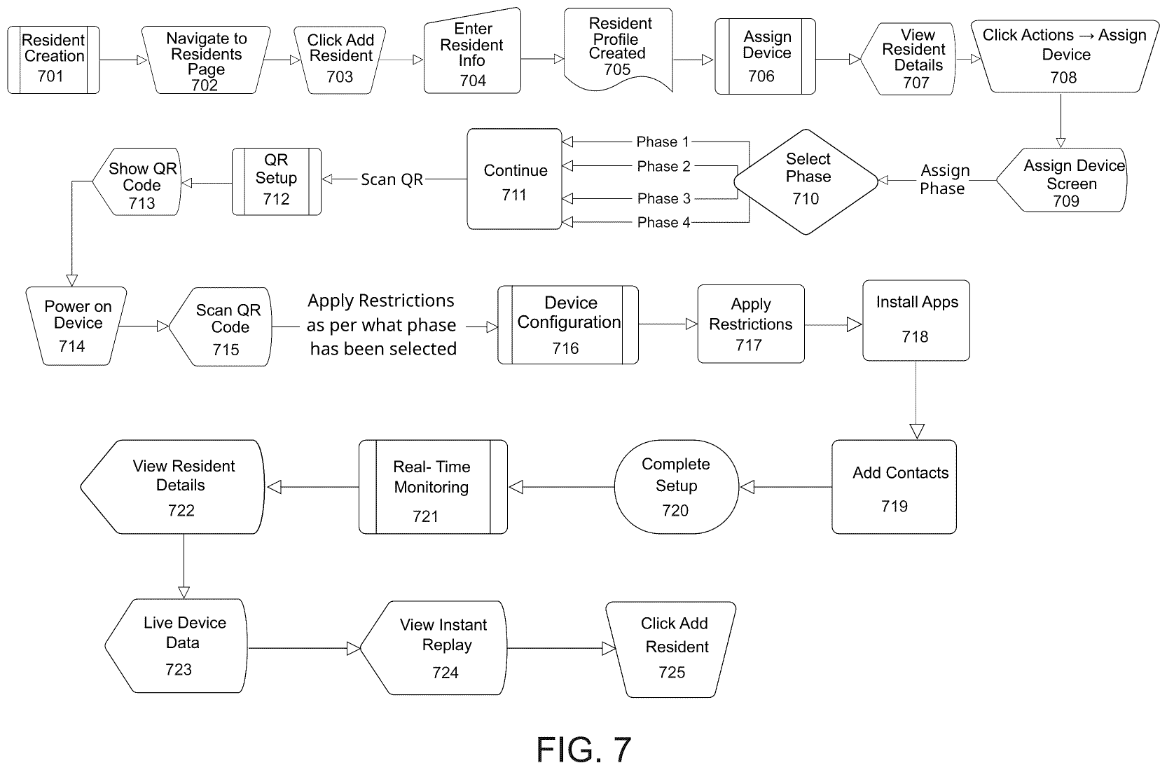

FIG. 7 is a flow diagram illustrating resident creation, device assignment, and onboarding with phase-based restrictions. In one embodiment, the system supports onboarding of new residents by creating resident profiles, assigning devices, and configuring access phases. Administrators may create and manage resident accounts from a dashboard, assign a device through QR code setup, and apply restrictions based on organizationally defined phases. Each phase specifies limits on applications, contacts, and features such as camera or Wi-Fi access. Once onboarding is complete, the system provides real-time monitoring, instant replay, and editing of contact data to support ongoing oversight.

Referring now to FIG. 7, in step 701 a resident profile is initiated by navigating to the residents page. In step 702 the administrator selects “Add Resident.” In step 704, resident information is entered, and in step 705 a resident profile is created. In step 706, a device is assigned to the resident by selecting the resident profile and viewing resident details (707). In step 708, the administrator selects “Actions→Assign Device” to open the assigned device screen (709). In step 710, the administrator selects a phase, which may include Phase 1, Phase 2, Phase 3, or Phase 4 and the process continues 711. In step 712, the system generates a QR code for device setup and it is shown (713). In step 714, the assigned device is powered on and the QR code is scanned (715). Next, the restrictions are applied automatically according to the selected phase. In step 716, the device configuration process begins, including applying restrictions (717), installing apps (718), and adding contacts (719). In step 720, setup is completed and the device is linked to the resident profile. In step 721, real-time monitoring is activated for the resident device. The dashboard provides access to view the resident details (722) to live device data (723) and supports viewing instant replays of device activity (724). In step 725, administrators may also edit or delete contacts associated with the resident profile.

The system supports organization-defined phases. In one example, Phase 1 may allow open device usage with unrestricted app installation, Phase 2 may limit available apps to six and allow limited contacts, Phase 3 may permit eight apps and expand contacts, while Phase 4 may enforce the most stringent controls, such as blocking Wi-Fi, prohibiting app deletions, restricting apps to four, limiting contacts, and enabling live location tracking. The phases are configurable by the organization and may be tailored to specific operational needs.

In another embodiment, the system is adapted for institutional device-management programs, such as recovery or residential facilities, where managers oversee resident devices through a centralized portal. In this embodiment, each device is provisioned with software agents that enforce restrictions defined by the portal, and each manager is provided with a dashboard interface to configure, monitor, and adjust device settings in real time.

In the early stages of treatment or recovery, the portal may configure the resident device for a highly restrictive operating state in which access is limited to a curated set of features and applications deemed essential to the participant's current phase. Non-essential applications, entertainment content, and unrestricted browsing may be disabled to provide a distraction-free digital environment. As the participant progresses, the portal may gradually reintroduce applications and functionality according to organizational policy, while maintaining safeguards to ensure controlled reintroduction of digital content. In later stages, the resident may be granted substantially unrestricted device access, but subject to continued monitoring and alerting functions.

The Device Management Portal provides multiple functional modules. In one embodiment: (a) Participant Profile Management. The portal maintains records of each participant's intake, progress, and permissions, and links each record to assigned devices. Administrators may create, modify, and track these profiles through the dashboard. (b) Permissions and Restrictions. The portal enforces granular control over applications, content, and device features. Restrictions may include disabling non-essential apps, blocking categories of content, or limiting browsing capabilities. These restrictions may be modified over time to reflect recovery progress. (c) Custom Restriction Policies. Administrators may define policies tailored to an individual participant, such as allowing only selected incoming/outgoing calls or SMS, setting time limits on app usage, or blocking specified communication tools. (d) Real-Time Monitoring and Alerts. The portal monitors device activity and generates alerts when thresholds are exceeded, such as attempts to access blocked content or misuse of communication features. (e) Remote Management. Administrators may perform remote actions including pushing updates, changing settings, locking or wiping devices, or granting and revoking permissions without physical access to the device. (f) Stage-Based Automation. The portal may apply predefined configuration sets corresponding to stages of treatment. When a participant transitions between stages, the associated device configuration is automatically applied without manual intervention. (g) Report Generation. Detailed reports on usage, restriction enforcement, and participant engagement may be generated for compliance tracking and treatment planning.

As illustrated in FIG. 6, the portal may also apply curfew enforcement to resident devices. A manager may schedule curfews during therapy sessions, group activities, or rest periods. During curfew, devices enter a minimal usage mode in which non-essential applications are disabled, but essential functions such as the Resident App remain available. Managers may remotely adjust curfew parameters, monitor compliance, and lift or extend curfews as needed.

As illustrated in FIG. 7, the resident onboarding and phase-based restriction process may also be implemented as pillar-based management for enterprise deployments. In one example, a first pillar may provide maximal restrictions (e.g., essential apps only, no browsing or social media), with restrictions progressively relaxed in subsequent pillars until the final pillar provides near-full access. Pillar transitions may be controlled by administrators and recorded in the portal.

The portal may further incorporate a Mandatory Pulse Surveys module. Administrators may configure periodic or on-demand surveys to assess resident well-being, stress levels, or compliance with treatment objectives. Responses are collected via the Resident App, processed by the backend, and aggregated into real-time analytics dashboards to inform staff decisions.

In another embodiment, an Offsite Location Request feature allows residents to request permission for external activities (e.g., appointments, family visits). Requests are initiated through the Resident App, transmitted to the portal, and logged for manager review and approval. Approved requests are stored with timestamps and associated notes, providing an auditable record of resident movement.

The portal may also provide a Resident Incentives and Goal Tracking module. This module enables staff to assign individualized goals and milestones. Progress toward these goals is tracked automatically, and residents may receive rewards, points, or incentives when milestones are achieved.

Finally, a Manager-Resident Messaging module provides secure, in-app communication distinct from native SMS. Managers may send reminders, instructions, or motivational messages directly to the resident. Communications are confined to the manager-resident channel, ensuring confidentiality and minimizing exposure to external or unsolicited messaging.

In an alternative embodiment, the features described herein are implemented within a custom Android-based operating system. The OS integrates (a) a camera/graphics pipeline hook and on-device inference service for nudity detection; (b) a package-management policy layer that enforces selective recording/uninstall decisions derived from risk-tagged metadata; (c) telephony and content-provider listeners for message ingestion supporting the suspicious-activity pipeline; and (d) a device-owner (DPC) policy controller to enforce curfew, grounding, and full-lockdown states, including emergency whitelists at the package level. Survey, incentives, location, and contact-management services execute as privileged system apps. Devices are provisioned by associating them with an account in the dashboard; devices may be factory-reset and re-provisioned to another user by scanning a setup code.

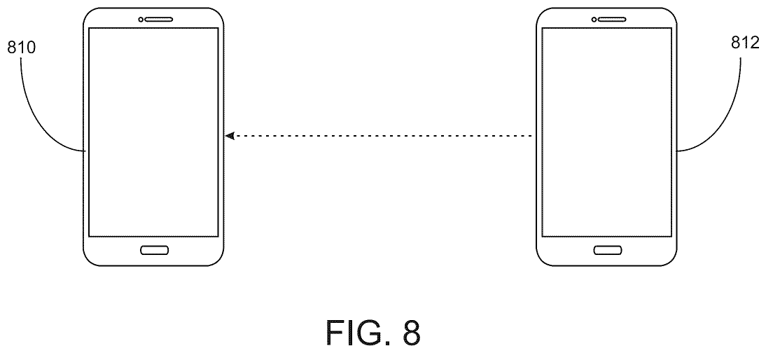

Referring now to FIG. 8, a schematic diagram of the specialized child device 810 is illustrated. The child device 810 is not a generic smartphone, but rather a purpose-built mobile device preloaded with a customized operating system and monitoring software configured to execute the modules of the present invention. The customized operating system incorporates modified system libraries, kernel-level hooks, and privileged applications that enable interception, analysis, and enforcement functions not possible on commercially available devices.

The child device 810 includes conventional smartphone hardware components such as a processor, memory, display, microphone, camera, and communication interfaces (cellular, Wi-Fi, Bluetooth). However, unlike generic smartphones, these components are tightly integrated with the monitoring software to provide system-level control. For example, the graphics and camera pipelines are extended to allow real-time screenshot capture and nudity detection; the telephony and SMS providers are intercepted to enable suspicious conversation analysis; and the package management subsystem is modified to support selective application recording and uninstallation.

The operating system further includes a Device Policy Controller (DPC) that enforces curfew, grounding, and lockdown restrictions, while maintaining emergency whitelists for essential contacts or applications. Each child device 810 is provisioned during onboarding through a QR-code setup procedure that binds the device to a parent or institutional dashboard account (via a secondary device 812 which may be a mobile device, desktop, or other computing device). Once provisioned, the device cannot be reset or operated outside the scope of the monitoring software without administrative authorization.

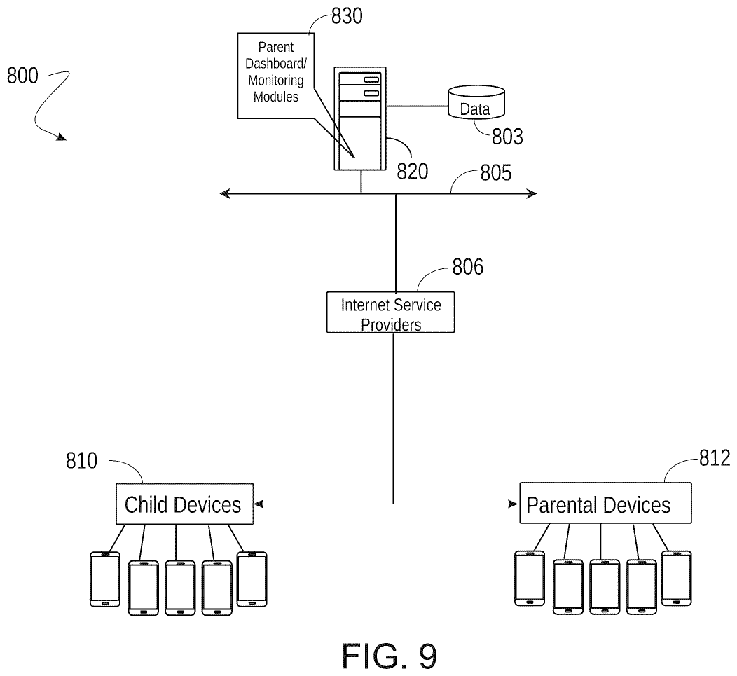

Referring now to FIG. 9, a network system overview 800 of the monitoring environment is provided. The system includes a specialized child device 810 as described in FIG. 8, a backend server 820, and a parent dashboard 801 accessible from a parent device 812 or administrator terminal. The child device 810 executes the monitoring modules of the invention under control of a customized operating system, while the backend server 820 provides centralized processing, storage 803, and alert distribution. The parent dashboard 830 presents real-time notifications, flagged content, and device control functions, enabling parents or administrators to manage the child device 810 remotely. Communication between these components may occur over secure cellular, Wi-Fi, or other network connections 805 via Internet service providers 806, with encryption ensuring confidentiality of transmitted data. The architecture ensures that each claimed feature is embodied in a particular machine-implemented system, integrating the child device, backend, and dashboard as cooperating elements of the invention.

As described in connection with FIGS. 1-7, all modules of the invention—including nudity detection, suspicious conversation analysis, suspicious contact flagging, grounding mode, audio monitoring, curfew enforcement, and enterprise phase-based management—are executed on the specialized child device 810. The configuration ensures that the claimed system is implemented on a particular machine with modified operating system components, rather than on a generic smartphone executing unmodified applications.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

What is claimed is:

1. A mobile device comprising:
a processor;
a memory storing instructions;
a camera configured to capture images;
a display configured to present an overlay; and
a monitoring module executed by the processor, the monitoring module being configured to: capture screenshots from the camera at defined intervals; convert each screenshot into a bitmap format; apply an embedded machine learning model to the bitmap to classify for nudity, the model configured to produce a classification result within a predetermined time;
wherein the classification result exceeds a nudity threshold, suspend running applications and present a locked-device overlay on the display; and
store an unlock code locally and verify a received unlock code against the stored unlock code to restore operation of the device.

2. The device of claim 1, wherein screenshots are captured at intervals of approximately 100 milliseconds.

3. The device of claim 1, wherein the machine learning model processes each bitmap in approximately 350 milliseconds.

4. The device of claim 1, wherein suspension of running applications includes halting session recording and disabling camera access.

5. The device of claim 1, wherein when the device is locked, the monitoring module transmits a session record to a backend server including a base64-encoded screenshot of the flagged content.

6. The device of claim 1, wherein if no internet connection is available, the monitoring module transmits an SMS alert to a parent using a SIM card of the device.

7. The device of claim 1, wherein the parent dashboard is configured to display a blurred version of the flagged image and permit selective unblurring.

8. The device of claim 1, wherein the monitoring module is further configured to receive a Firebase Cloud Messaging (FCM) signal from the backend server to unlock the device upon parental approval.

9. The device of claim 1, wherein the device overlay displays a nudity detected message during lockout.

10. A system comprising:
a child device configured to execute an operating system with a package management policy layer;
a backend server communicatively coupled to the child device; and
a parent dashboard configured to display app metadata and control options;
wherein the child device is configured to: detect installation of an application; collect metadata including at least application name, developer, category, permissions, and content rating; evaluate the metadata to assign one or more risk flags selected from adult content indicators, risky permissions, risky categories, and unverified developer; and transmit a risk-tagged metadata package to the backend server; and
wherein the parent dashboard is configured to: display the risk-tagged metadata package; and present decision options including (i) don't record, (ii) uninstall, or (iii) no action, wherein don't record disables feed visibility but preserves camera-based nudity monitoring on the child device.

11. The system of claim 10, wherein the risk evaluation assigns an adult content flag when the application category is dating, live streaming, or private chat.

12. The system of claim 10, wherein the risk evaluation assigns a risky permission flag when the application requests at least one of camera, microphone, SMS, location, overlay, or usage statistics without justification.

13. The system of claim 10, wherein the risk evaluation assigns an unverified developer flag when the application is published by a developer lacking established reputation.

14. The system of claim 10, wherein a decision to uninstall the application is irreversible within the parent dashboard.

15. The system of claim 10, wherein a decision to don't record disables feed visibility but does not disable camera-based nudity monitoring.

16. The system of claim 10, wherein the parent dashboard is configured to update review tags when classification of an application changes due to new metadata.

17. An enterprise device management system comprising:
a plurality of resident devices each configured with a device-owner policy controller;
a manager portal accessible via a dashboard; and
a backend server configured to synchronize device policies; wherein the manager portal is configured to: create resident profiles and assign devices via QR code setup; apply phase-based restrictions defining allowable applications, contacts, and communication functions; enforce scheduled curfews that trigger overlays and minimal usage mode on the resident devices; dispatch mandatory pulse surveys to resident devices and aggregate responses; configure incentive and goal tracking programs that deliver rewards to residents upon milestone completion; and provide secure manager-resident messaging confined to in-portal communication channels.

18. The system of claim 17, wherein phase-based restrictions are implemented as organizationally defined pillars with progressively relaxed application and communication permissions.

19. The system of claim 17, wherein curfew enforcement displays an overlay on the resident device and initiates a countdown timer until curfew expiration.

20. The system of claim 17, wherein the manager portal is configured to generate detailed reports summarizing resident device usage, restriction enforcement events, and compliance with recovery guidelines.
